(19) United States
(12) Patent Application Publication
(10) Pub. No.: US 2015/0347355 A1
(43) Pub. Date: Dec. 3, 2015

(54) Assistive Reading Tool

(71) Applicant: Laura Marie Kasbar, Spokane, WA (US)

(72) Inventor: Laura Marie Kasbar, Spokane, WA (US)

(21) Appl. No.: 14/726,430

(22) Filed: May 29, 2015

Related U.S. Application Data
(60) Provisional application No. 62/004,703, filed on May 29, 2014.

(51) Int. Cl. G06F 17/21; G06F 3/16; G06F 17/30

(52) U.S. Cl. CPC G06F 17/212; G06F 17/30076; G06F 3/167

(57) ABSTRACT

A method for providing an assistive reading tool that allows a reader to control exactly how much of the text is revealed in a document. A text file is selected, along with a document reveal selection that determines a grouping of characters for displaying text of the text file. A hidden document is formatted using the text file, wherein the hidden document restricts the text from the text file that is displayed to the reader. The hidden document is displayed to the reader through a display window, wherein a progression command entered by the reader is used to display a subsequent portion of the hidden document, wherein the subsequent portion is the grouping of characters that can be either a letter, a word, a sentence, or a paragraph; therefore, allowing the reader to reveal the hidden document letter by letter, word by word, sentence by sentence, or paragraph by paragraph.

The current application claims a priority to the U.S. Provisional Patent application Ser. No. 62/004,703 filed on May 29, 2014.

### FIELD OF THE INVENTION

The present invention relates generally to the field of computer-based reading.

More specifically, the present invention is an assistive reading tool that allows the reader to control exactly how much of the text is revealed in a document.

### BACKGROUND OF THE INVENTION

Dyslexia is a reading disorder that is believed to affect three to seven percent of the population and is characterized by trouble reading despite normal intelligence. The effects of dyslexia are different for each person and they occur at various degrees. Some of the effects of dyslexia include problems with sounding out words, spelling words, reading quickly, writing words, pronouncing words, and reading comprehension. As the effects of dyslexia and the degree to which an individual suffers the effects vary, the treatment of dyslexia often involves adjusting teaching methods in order to cater to each individuals specific needs.

It is well established that some people with dyslexia have a difficult time tracking the words across the page and that the distraction of all of the words on a single page can be a significant detriment to reading fluency. Tools with plastic windows to allow the reader to block out lines or letters on a written page have been shown to be useful to improve reading fluency, but these are imperfect as it is impossible to block out all other symbols both before and after the desired symbol. It is also not possible to block out all other texts except for the complete sentence that one is reading at that time using manual methods.

Therefore it is the object of the present invention to provide an assistive reading tool on a computer-based reading platform that allows a reader to control exactly how much of the text is revealed. The present invention allows the reader to upload a text file or select from a plurality of pre-loaded text files categorized by a plurality of reading levels. Once the text file is selected by the reader, the text file is formatted into a hidden document that selectively displays the text to the reader. The reader also selects a document reveal selection that determines a grouping of characters that is displayed each time the reader enters a progression command. The grouping of characters can be either a letter, a word, a sentence, or a paragraph, wherein the hidden document can be displayed letter by letter, word by word, sentence by sentence, or paragraph by paragraph.

### BRIEF DESCRIPTION OF THE DRAWINGS

FIG. 1 is a flowchart depicting steps for sequentially revealing portions of a hidden document that is derived from a text file;

FIG. 2 is a flowchart thereof, further depicting steps for the reader providing a document reveal selection;

FIG. 3 is a flowchart thereof, further depicting steps for the reader uploading the text file from a computer-readable storage medium;

FIG. 4 is a flowchart thereof, further depicting steps for the reader selecting the text file from a plurality of pre-loaded text files; and

FIG. 5 is a flowchart thereof, further depicting steps for hiding a previous portion of the hidden document in an alternative embodiment.

FIG. 6 is an illustration of the user interface through which the reader makes the reading level selection, the document selection, and the document reveal selection.

FIG. 7 is an illustration of the hidden document displayed through a display window as the hidden document is first opened, wherein only the initial portion is graphically displayed, and wherein the initial portion is a sentence.

FIG. 8 is an illustration of the hidden document, wherein the subsequent portion is displayed in addition to the initial portion after the progression command is received, and wherein the initial portion and the subsequent portion are both a sentence.

### DETAIL DESCRIPTIONS OF THE INVENTION

All illustrations of the drawings are for the purpose of describing selected versions of the present invention and are not intended to limit the scope of the present invention.

The present invention is an assistive reading tool that allows the reader to control exactly how much of the text is revealed in a document. The present invention allows a user to reveal portions of a document either letter by letter, word by word, sentence by sentence, or paragraph by paragraph. The assistive reading tool is implemented as a software by executing computer-executable instructions stored on a non-transitory computer-readable medium. The computer-readable medium can be implemented as a local storage medium, such as a digital video disc (DVD), or a remote storage medium, such as a server used to host a web-based platform.

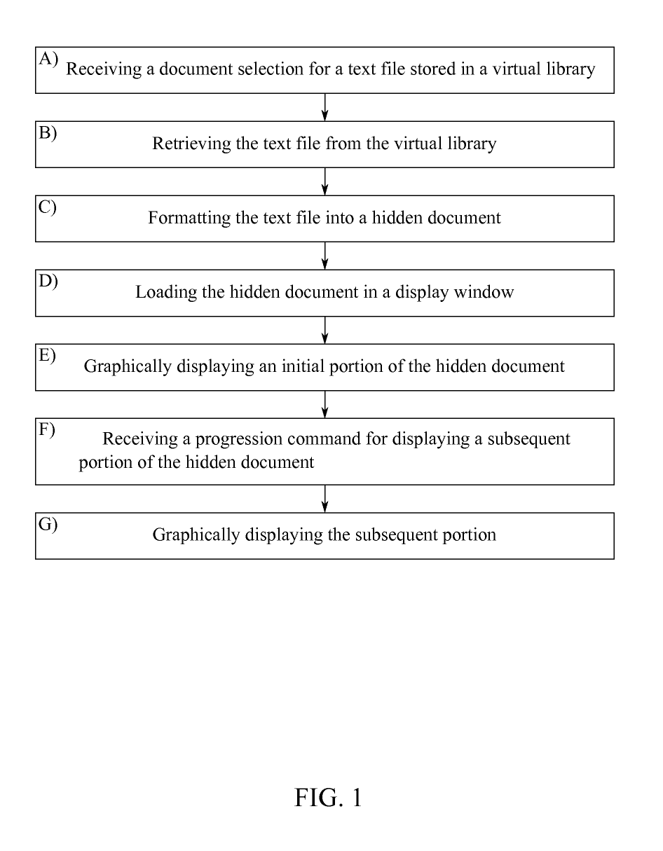

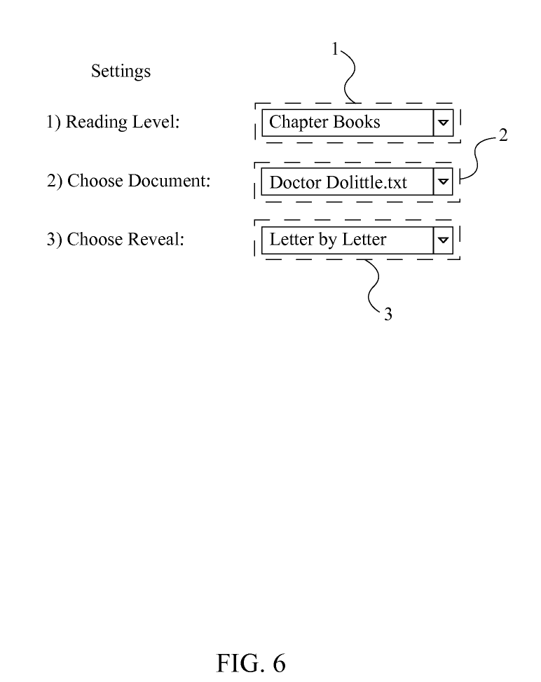

The software of the present invention provides a user interface through which the user can interact with the software and vice versa. Through the user interface the, the user is able to interact with data stored on the non-transitory computer-readable medium. In reference to FIG. 1 and FIG. 6, to begin using the assistive reading tool, the user first makes a document selection 2 for a text file that is stored in a virtual library. The virtual library can be created and stored on the non-transitory computer-readable medium, or locally on the computer the user is utilizing to run the software.

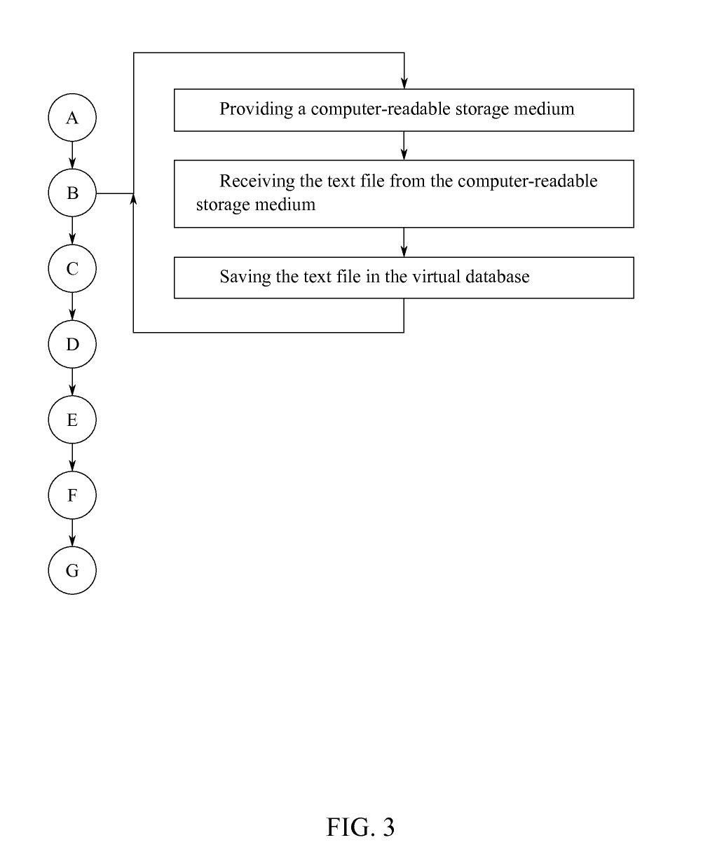

The text file can either be uploaded by the user or selected from a plurality of pre-loaded text files. In reference to FIG. 3, if the text file is uploaded, then the user selects the text file to be uploaded from a computer-readable storage medium. The computer-readable storage medium can be an internal hard drive, external hard drive, flash drive, universal serial bus (USB) drive, etc. Upon uploading the text file, the non-transitory computer-readable medium receives the text file from the computer-readable storage medium and saves the text file in the virtual database.

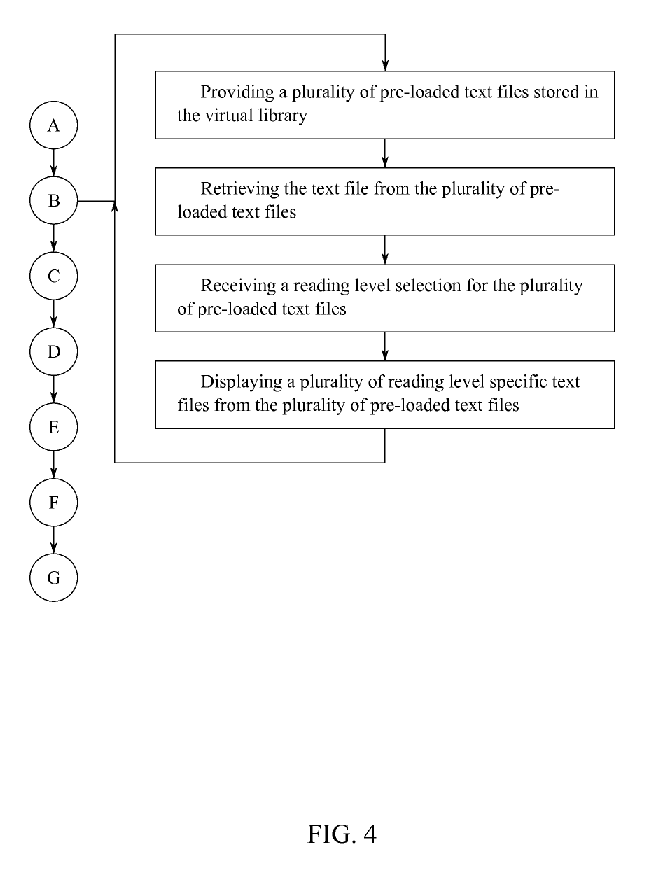

In reference to FIG. 4 and FIG. 6, if the text file is selected from the plurality of pre-loaded text files, then the user must also make a reading level selection 1 for the plurality of pre-loaded text files. The reading level selection 1 is made before the document selection 2, wherein the non-transitory computer-readable medium receives the reading level selection 1 and displays, through the user interface, a plurality of reading level specific text files from the plurality of pre-loaded text files. The user then makes the document selection 2 by selecting the text file from the plurality of reading level specific text files, wherein the non-transitory computer-readable medium retrieves the text file from the plurality of pre-loaded text files.

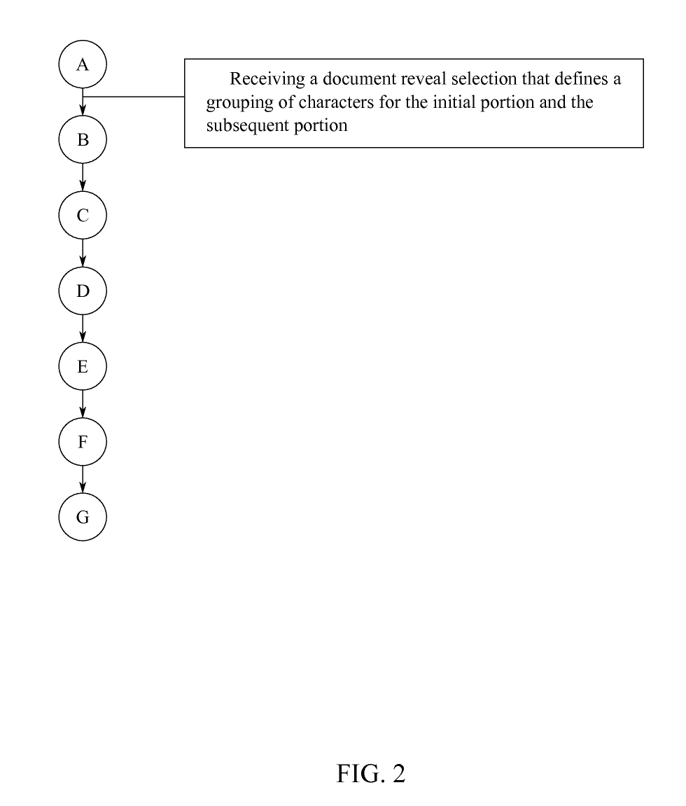

Once the user has entered the document selection 2, the non-transitory computer-readable medium retrieves the text file from the virtual database. In reference to FIG. 2 and FIG. 6, the user must also make a document reveal selection 3 in addition to the document selection 2. The document reveal selection 3 defines a grouping of characters that can be a letter, a word, a sentence, or a paragraph. Therefore, through the document reveal selection 3, the user determines how much text is displayed, or the pace at which text is displayed, through the user interface in a given instance.

In reference to FIG. 1-2, once the document selection 2 and the document reveal selection 3 are received, and the non-transitory computer-readable medium retrieves the text file, the non-transitory computer-readable medium formats the text file into a hidden document. The hidden document is a file that contains the exact text of the text file, however, the hidden document is formatted such that the text is initially invisible to the user through the user interface. This can be accomplished by continuously updating the hidden document through copying sections of text from the text file, changing the color of the font of the text to match the background, overlaying a graphic on the text, or any other means to restrict the user from being able to view the text.

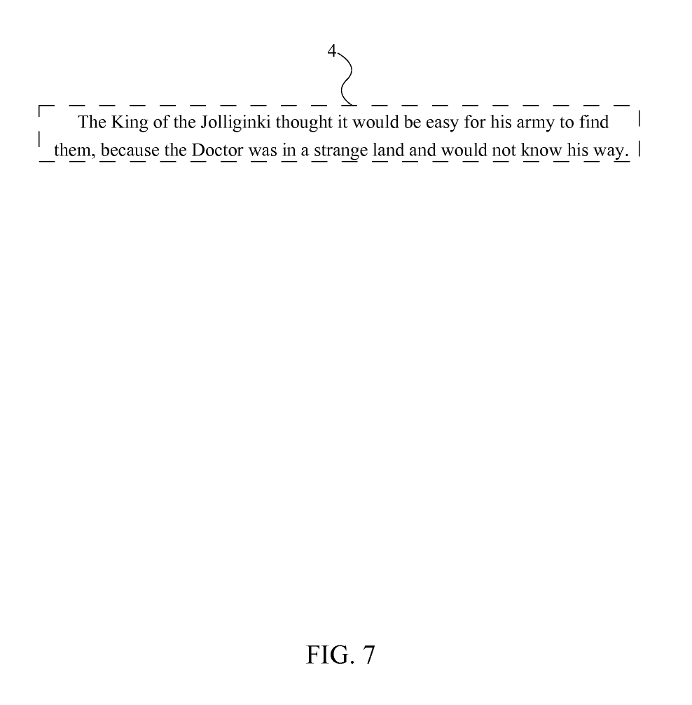

In reference to FIG. 1, the non-transitory computer-readable medium loads the hidden document into a display window of the user interface, wherein the non-transitory computer-readable medium graphically displays an initial portion 4 of the hidden document, as depicted in FIG. 7. The length, or size, of the initial portion 4 is defined by the document reveal selection 3, wherein the grouping of characters of the initial portion 4 is either a letter, a word, a sentence, or a paragraph. In order to reveal the remaining text of the hidden document, the user must enter a progression command for graphically displaying a subsequent portion 5 of the hidden document. Similar to the initial portion 4, the length, or size, of the subsequent portion 5 is defined by the document reveal selection 3, wherein the grouping of characters of the subsequent portion 5 is either a letter, a word, a sentence, or a paragraph.

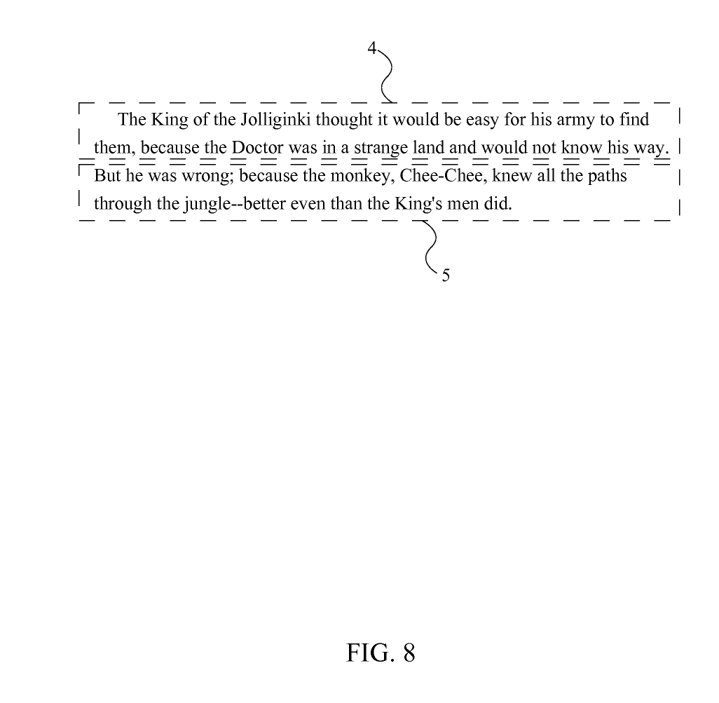

The user can continue to enter the progression command, sequentially revealing the hidden document by the subsequent portion 5, until the hidden document is fully revealed to the user. It is to be noted that the grouping of characters for the subsequent portion 5 is to be identical to the grouping of characters for the initial portion 4, as depicted in FIG. 8. More specifically, the initial portion 4 and the subsequent portion 5 are either both a letter, both a word, both a sentence, or both a paragraph.

The specific way in which the hidden document is formatted and the text of the hidden document is added or revealed may vary in different embodiments of the present invention. In one embodiment of the present invention, the hidden document is constantly formatted, wherein each time the progression command is entered, the subsequent portion 5 of the hidden document is loaded from the text file. In other words, the non-transitory computer-readable medium searches for the subsequent portion 5 within the text file and then copies the subsequent portion 5 into the hidden document, wherein the user can view the subsequent portion 5. The initial portion 4 is similarly copied from the text file into the hidden document when the hidden document is initially loaded into the display window.

In other embodiments of the present invention, the initial portion 4 is revealed, or displayed, to the user by changing the font of the text of the initial portion 4 to contrast the background, removing overlying graphics on the text of the initial portion 4, or performing any other actions corresponding to how the text of the hidden document is initially restricted. Similarly, the subsequent portion 5 is revealed, or displayed, to the user by changing the font of the text of the subsequent portion 5 to contrast the background, removing overlying graphics on the text of the subsequent portion 5, or performing any other actions corresponding to how the text of the hidden document is initially restricted.

In reference to FIG. 1 and FIG. 8, each time the non-transitory computer-readable medium receives the progression command, the subsequent portion 5 of the hidden document is graphically displayed, or revealed, by the non-transitory computer-readable medium. The progression command can be entered by the user in a number of different computer understandable inputs. In the preferred embodiment of the present invention, the progression command is entered as either a keyboard input or a mouse input, such as clicking the space bar (or another selected key of the keyboard) or a selected mouse button, respectively. In other embodiments of the present invention, the progression command is entered as a touch input, such as through a touchscreen or touchpad, or as a voice input through a microphone.

As previously stated, the document reveal selection 3 defines the grouping of characters for the initial portion 4 and the subsequent portion 5, wherein the grouping of characters can be a letter, a word, a sentence, or a paragraph. Therefore, the document reveal selection 3 allows the text of the hidden document to be displayed letter by letter, word by word, sentence by sentence, or paragraph by paragraph. This allows the user to select the optimal reveal size of the grouping of characters to best suit the reading comprehension level of the user.

In the document reveal selection 3 being letter by letter, the text in the hidden document is revealed one letter at a time. Therefore, the first letter of the text file is displayed as the initial portion 4 of the hidden document. The first time the progression command is entered, the second letter of the text file is displayed as the subsequent portion 5 of the text document. The second time the progression command is entered, the third letter of the text file is displayed as the subsequent portion 5 of the text document, and so on and so forth until the entirety of the hidden document is displayed.

In the document reveal selection 3 being word by word, the text in the hidden document is revealed one word at a time. Therefore, the first word of the text file is displayed as the initial portion 4 of the hidden document. The first time the progression command is entered, the second word of the text file is displayed as the subsequent portion 5 of the text document. The second time the progression command is entered, the third word of the text file is displayed as the subsequent portion 5 of the text document, and so on and so forth until the entirety of the hidden document is displayed.

In the document reveal selection 3 being sentence by sentence, the text in the hidden document is revealed one sentence at a time. Therefore, the first sentence of the text file is displayed as the initial portion 4 of the hidden document. The first time the progression command is entered, the second sentence of the text file is displayed as the subsequent portion 5 of the text document. The second time the progression command is entered, the third sentence of the text file is displayed as the subsequent portion 5 of the text document, and so on and so forth until the entirety of the hidden document is displayed.

In the document reveal selection 3 being paragraph by paragraph, the text in the hidden document is revealed one paragraph at a time. Therefore, the first paragraph of the text file is displayed as the initial portion 4 of the hidden document. The first time the progression command is entered, the second paragraph of the text file is displayed as the subsequent portion 5 of the text document. The second time the progression command is entered, the third paragraph of the text file is displayed as the subsequent portion 5 of the text document, and so on and so forth until the entirety of the hidden document is displayed.

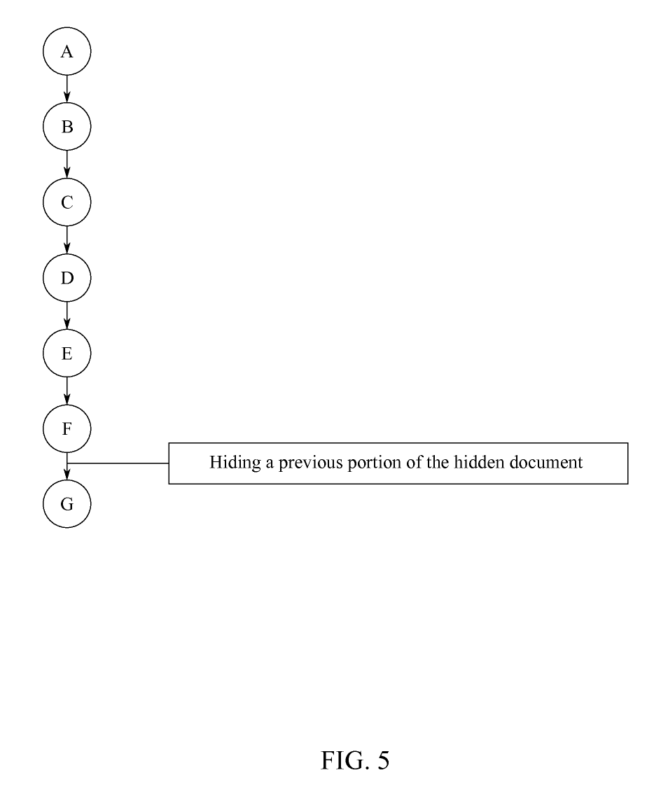

In reference to FIG. 5, in an alternative embodiment of the present invention, a previous portion of the hidden document is hidden, or removed, each time the progression command is entered. In this way, only a single portion of the hidden document is visible at a given point in time. Similar to the initial portion 4 and the hidden portion, the previous portion is a grouping of characters that can be either a letter, a word, a sentence, or a paragraph. The size of the grouping of characters of the previous portion may be the same as or different than the size of the grouping of characters of the initial portion 4 and the subsequent portion 5.

In one example of the alternative embodiment, the first word of the text file is displayed as the initial portion 4 of the hidden document. The first time the progression command is entered, the second word of the text file is displayed as the subsequent portion 5 of the text document and the first word is hidden, or removed, as the previous portion. The second time the progression command is entered, the third word of the text file is displayed as the subsequent portion 5 of the text document and the second word is hidden as the previous portion, and so on and so forth until each word of the hidden document is displayed individually.

In another example of the alternative embodiment, the first letter of the first word of the text file is displayed as the initial portion 4 of the hidden document. The first time the progression command is entered, the second letter of the first word of the text file is displayed as the subsequent portion 5 of the text document. The second time the progression command is entered, the third letter of the first word of the text file is displayed as the subsequent portion 5 of the text document and so on and so forth until the first word of the hidden document is displayed. The following time the progression command is entered, the first word is hidden as the previous portion, while the first letter of the second word is displayed as the subsequent portion 5.

Although the invention has been explained in relation to its preferred embodiment, it is to be understood that many other possible modifications and variations can be made without departing from the spirit and scope of the invention as hereinafter claimed.

What is claimed is:

1. A method for providing an assistive reading tool by executing computer-executable instructions stored on a non-transitory computer-readable medium, the method comprises the steps of:
receiving a document selection for a text file stored in a virtual library;
retrieving the text file from the virtual library;
formatting the text file into a hidden document;
loading the hidden document in a display window;
graphically displaying an initial portion of the hidden document;
receiving a progression command for displaying a subsequent portion of the hidden document; and
graphically displaying the subsequent portion.

2. The method for providing an assistive reading tool by executing computer-executable instructions stored on a non-transitory computer-readable medium, the method as claimed in claim 1, wherein the initial portion and the subsequent portion are a letter.

3. The method for providing an assistive reading tool by executing computer-executable instructions stored on a non-transitory computer-readable medium, the method as claimed in claim 1, wherein the initial portion and the subsequent portion are a word.

4. The method for providing an assistive reading tool by executing computer-executable instructions stored on a non-transitory computer-readable medium, the method as claimed in claim 1, wherein the initial portion and the subsequent portion are a sentence.

5. The method for providing an assistive reading tool by executing computer-executable instructions stored on a non-transitory computer-readable medium, the method as claimed in claim 1, wherein the initial portion and the subsequent portion are a paragraph.

6. The method for providing an assistive reading tool by executing computer-executable instructions stored on a non-transitory computer-readable medium, the method as claimed in claim 1 further comprises the steps of:
receiving a document reveal selection that defines a grouping of characters for the initial portion and the subsequent portion.

7. The method for providing an assistive reading tool by executing computer-executable instructions stored on a non-transitory computer-readable medium, the method as claimed in claim 1 further comprises the steps of:
providing a computer-readable storage medium;
receiving the text file from the computer-readable storage medium; and
saving the text file in the virtual database.

8. The method for providing an assistive reading tool by executing computer-executable instructions stored on a non-transitory computer-readable medium, the method as claimed in claim 1 further comprises the steps of:
providing a plurality of pre-loaded text files stored in the virtual library; and
retrieving the text file from the plurality of pre-loaded text files.

9. The method for providing an assistive reading tool by executing computer-executable instructions stored on a non-transitory computer-readable medium, the method as claimed in claim 8 further comprises the steps of:
receiving a reading level selection for the plurality of pre-loaded text files; and
displaying a plurality of reading level specific text files from the plurality of pre-loaded text files.

10. The method for providing an assistive reading tool by executing computer-executable instructions stored on a non-transitory computer-readable medium, the method as claimed in claim 1 further comprises the steps of:
hiding a previous portion of the hidden document.

11. The method for providing an assistive reading tool by executing computer-executable instructions stored on a non-transitory computer-readable medium, the method as claimed in claim 10, wherein the previous portion is a letter.

12. The method for providing an assistive reading tool by executing computer-executable instructions stored on a non-transitory computer-readable medium, the method as claimed in claim 10, wherein the previous portion is a word.

13. The method for providing an assistive reading tool by executing computer-executable instructions stored on a non-transitory computer-readable medium, the method as claimed in claim 10, wherein the previous portion is a sentence.

14. The method for providing an assistive reading tool by executing computer-executable instructions stored on a non-transitory computer-readable medium, the method as claimed in claim 10, wherein the previous portion is a paragraph.

15. The method for providing an assistive reading tool by executing computer-executable instructions stored on a non-transitory computer-readable medium, the method as claimed in claim 1, wherein the progression command is a keyboard input.

16. The method for providing an assistive reading tool by executing computer-executable instructions stored on a non-transitory computer-readable medium, the method as claimed in claim 1, wherein the progression command is a mouse input.

17. The method for providing an assistive reading tool by executing computer-executable instructions stored on a non-transitory computer-readable medium, the method as claimed in claim 1, wherein the progression command is a touch input.

18. The method for providing an assistive reading tool by executing computer-executable instructions stored on a non-transitory computer-readable medium, the method as claimed in claim 1, wherein the progression command is a voice input.
